(19) United States
(12) Patent Application Publication
(10) Pub. No.: US 2019/0117486 A1
(43) Pub. Date: Apr. 25, 2019

(54) PORTABLE DISABILITY ACCESS DEVICE

(71) Applicants: David Stratton, Newstead (AU); Rodney Brooke, Talbot (AU)

(72) Inventor: David Stratton, Newstead (AU)

(21) Appl. No.: 16/098,714

(22) PCT Filed: Apr. 28, 2017
(86) PCT No.: PCT/AU2017/000097

§ 371 Date: Nov. 2, 2018

(30) Foreign Application Priority Data
May 3, 2016 (AU) 2016901621

(51) Int. Cl. A61G 7/053; A47C 21/00

(52) U.S. Cl. CPC A61G 7/0533; A47C 21/00

(57) ABSTRACT

A foldable, portable disability bed support which has a portion disposable under a mattress and a vertical post for use in self-supporting a disabled person. The bed support includes a base connector to which the vertical post is attached. The base connector is adapted to accept attachment of the base arms in either an operative position or in a folded position in which the base arms lie alongside the support post.

This invention relates to a device for use by disabled people to assist them in moving around a bed, to raise themselves to a sitting positon or to assist them in moving between a bed and a wheelchair.

### BACKGROUND TO THE INVENTION

The idea of a Bed post or Pole has been around for about 20 years. There are a number of different designs manufactured and offered for sale. The primary purpose of a Bed Post is to provide a stable post at a suitable location along the side of a bed that a person can use to assist them in moving themselves around on the bed and in raising themselves to a sitting position on the side of the bed or conversely assisting to transfer from a wheel chair to the bed.

Currently available Bed Posts fit into two classes. Permanently attached and Removable Bed Posts. Most hospitals that deal with disabled patients have the permanent type. Removable types are generally owned by their user and are taken with them if they move from one residential location to another.

The removable types are generally quite ungainly and take up a lot of space when being moved. They all have a flat frame or plate that slides under the mattress of the bed to provide stability for the post that is fixed to the side of the base frame. The combination of the area of the base and the weight of the person lying/sitting on the bed provides the necessary support and restraint for the bed post to allow it to accept loads in any direction up to the maximum that a person can apply with their arm when in a lying or sitting position. Using AS1428.1-2009 for Grab Rails as a basis this maximum load is 1100 N.

Australian patent 2011218731 discloses a vertical post attachable to a four post bed frame.

Japanese publication 03376385 discloses a bed side support mountable on the bed frame.

Japanese publication 04315518 discloses a vertically slidable handrail attached to a floor board.

Occupational and Physiotherapists working in the disability sector see there is a place for removable bed posts in many situations with the exception of use where the mattress is narrow and very light and flexible (Thin Foam) or the person has cognitive issues that would limit their ability to recognize a dangerous situation. There have been several fatalities involving bed posts. Two scenarios are evident One is where the post has moved allowing a gap between the edge of the mattress and the post to develop which has resulted in a person's head becoming stuck in the gap. Complete rollover of the mattress and person has also resulting in fatalities.

Greater acceptance of the need to provide disability access in many parts of the world has resulted in more people with a disability travelling. The ungainly aspects of the bed post during travel have been highlighted when this travel involves flying.

WO2016/070227 by the present applicants discloses a bed post that provides a vertical post and a portion at right angles that is adapted to lie under a mattress. This design is useful but cumbersome and complicated to manufacture.

It is an object of this invention to ameliorate these problems.

### BRIEF DESCRIPTION OF THE INVENTION

To this end the present invention provides a foldable, portable disability bed support which has a portion disposable under a mattress and a vertical support for use in self-supporting a disabled person.

The base portion when inserted under a mattress has at least two arms radially extending from the vertical support.

The portion under the mattress creates a large virtual surface area extending from the upright post toward the centre of the mattress and extending laterally. This shape provides the resistance required to oppose the force applied to the upright post when the disabled person uses it to pull themselves into a sitting position or for support when transferring to a wheel chair.

In another aspect this invention provides a foldable, portable disability bed support which has a base portion consisting of at least two arms disposable under a mattress and a support attached vertically to the base portion for use in self-supporting a disabled person and the at least two arms are spaced apart and radially attached to the base of the vertical support. Preferably the bed support includes a base connector to which the vertical post is attached. This base connector is adapted to accept attachment of the base arms in either an operative position where the arms are at right angles to the support post or in a folded position in which the base arms lie alongside the support post. Preferably the base connector has two recesses for each arm; one recess aligning the arm alongside the vertical post; and the other recess aligning the arms at right angles to the support post. In a further preferred embodiment the base connector has a pivot recess for each arm and each arm has a spring loaded lock so that the arms are able to be placed in a folded position alongside the vertical post and an operative position at right angles to the support post.

The device is easily reassembled with all critical assembly connections identified. The advantages of this invention are:
Light weight (less than 5 kg). It is made from sections of Aluminium tube, and some solid aluminium parts.
Packs down quickly and easily to a manageable volume to fit into a case or its own bag.
Is easily and simply reassembled by plugging the parts together. A preferred alternative is for the radial arms to pivot about the base of the vertical post from an operative position to a foldable position for transportation.
When assembled all critical stress points and joints are inherently strong and safe. The joints between members may be a simple plug and socket design with an anti-rotation feature to maximize stability of the structure.

### DETAILED DESCRIPTION OF THE INVENTION

A preferred embodiment of the invention will now be described with reference to the drawings in which:

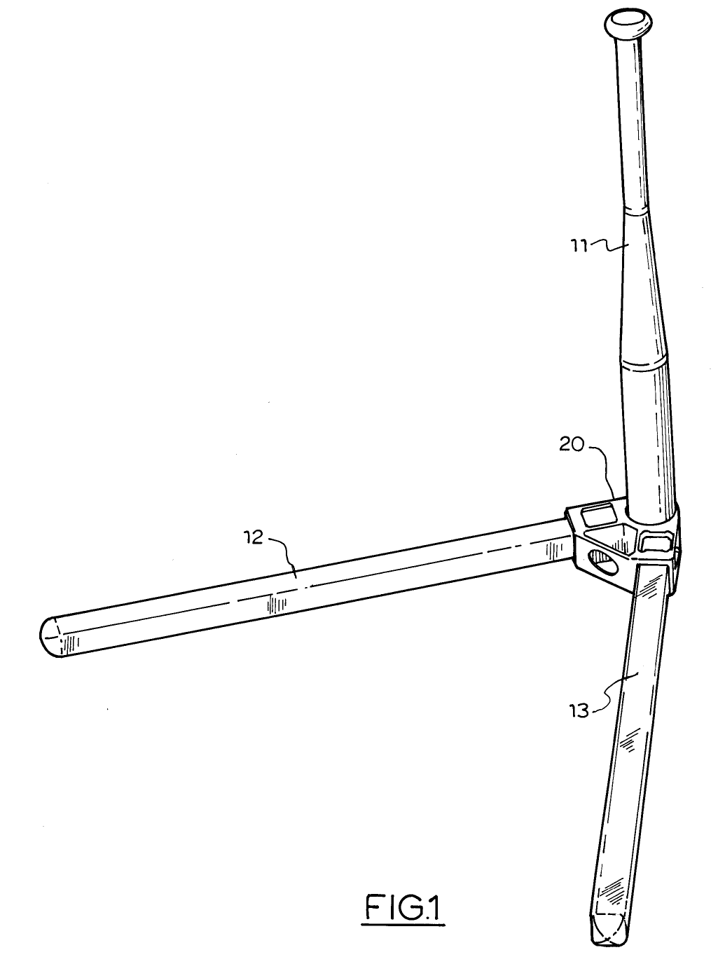

FIG. 1 is a perspective view of a first embodiment of the bed post of this invention;

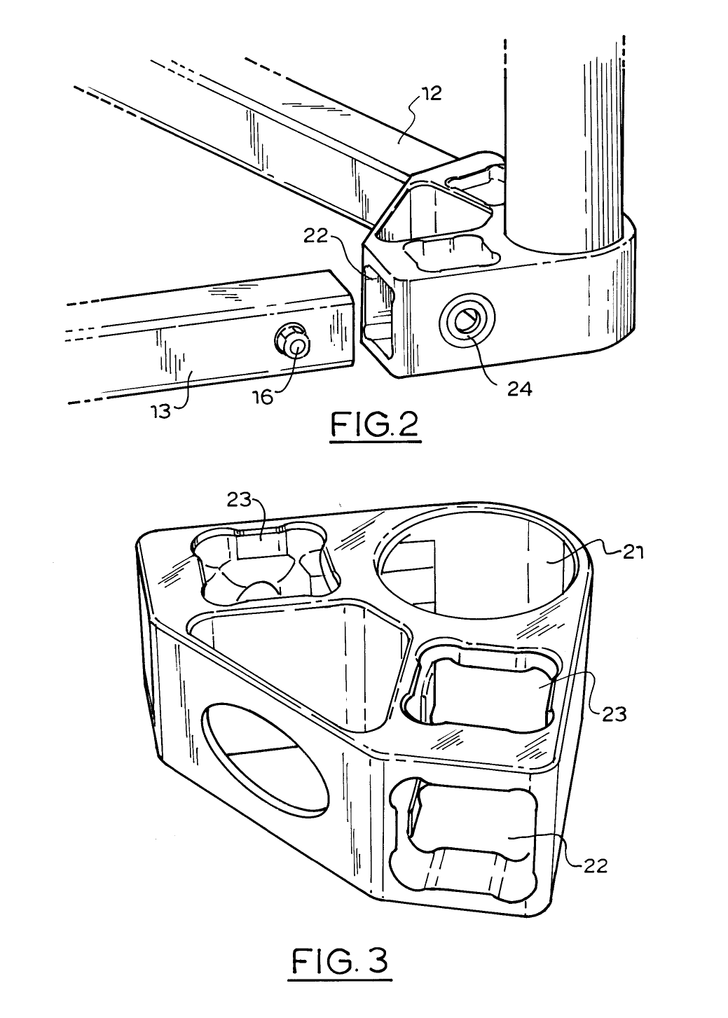

FIG. 2 is a detail showing the assembly of a leg to the vertical post of the embodiment of FIG. 1;

FIG. 3 is a perspective view of the base connector of the embodiment of FIG. 1;

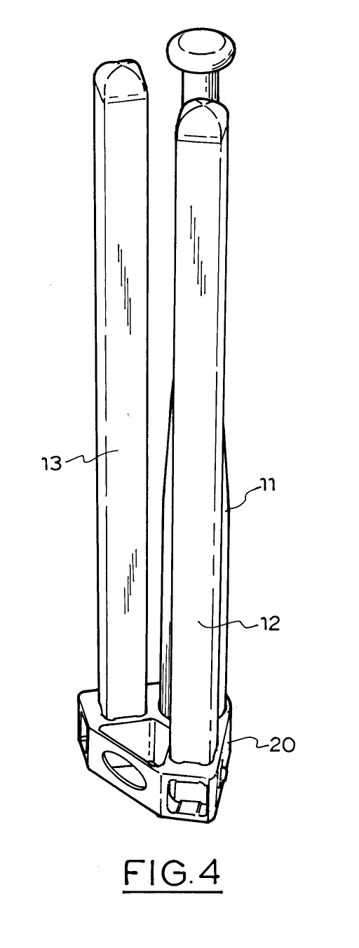

FIG. 4 is a view of the bed post of the embodiment of FIG. 1 in its folded position;

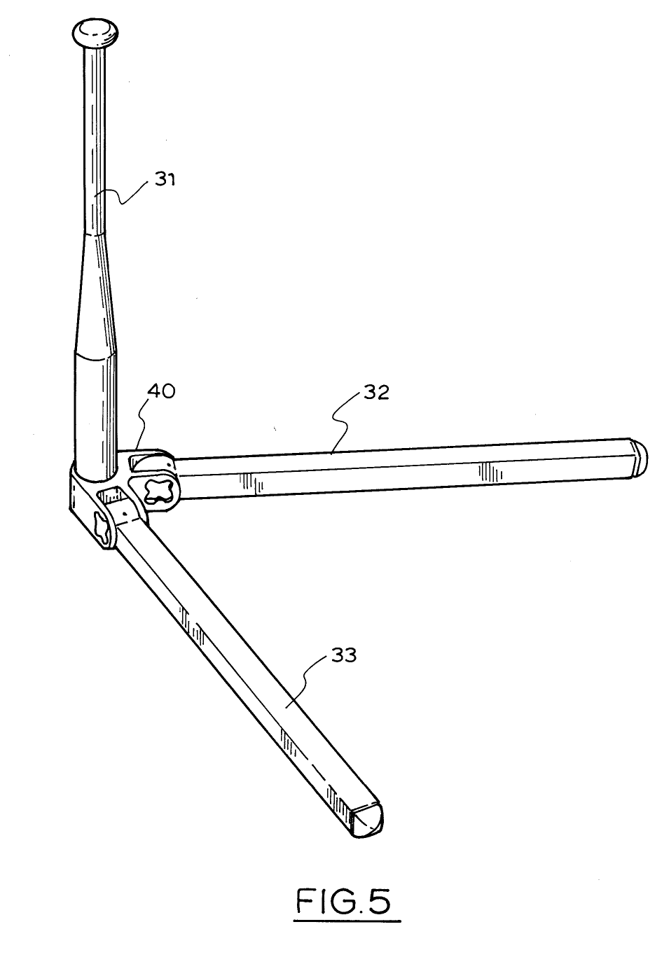

FIG. 5 is a perspective view of a second embodiment in its operative position;

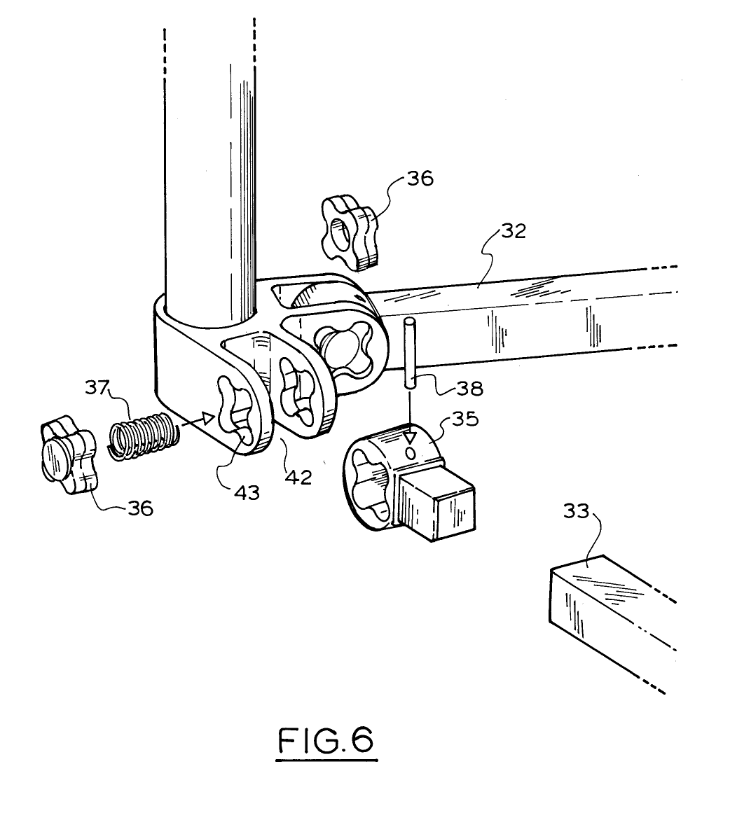

FIG. 6 is an exploded view illustrating the pivot lock system of the embodiment of FIG. 5;

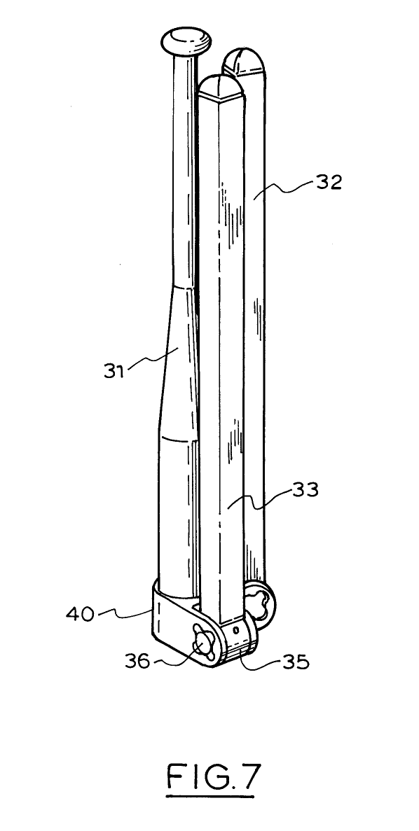

FIG. 7 is a view of the bed post of the embodiment of FIG. 5 in its folded position;

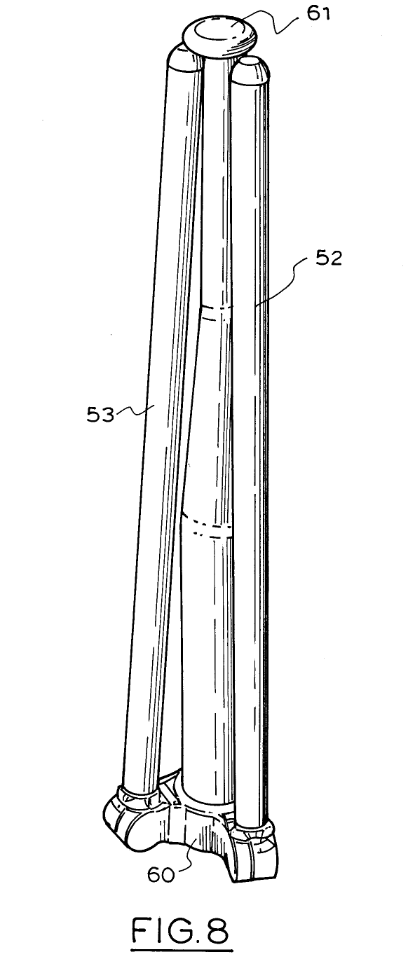

FIG. 8 is a view of the bed post of a further embodiment in its folded position;

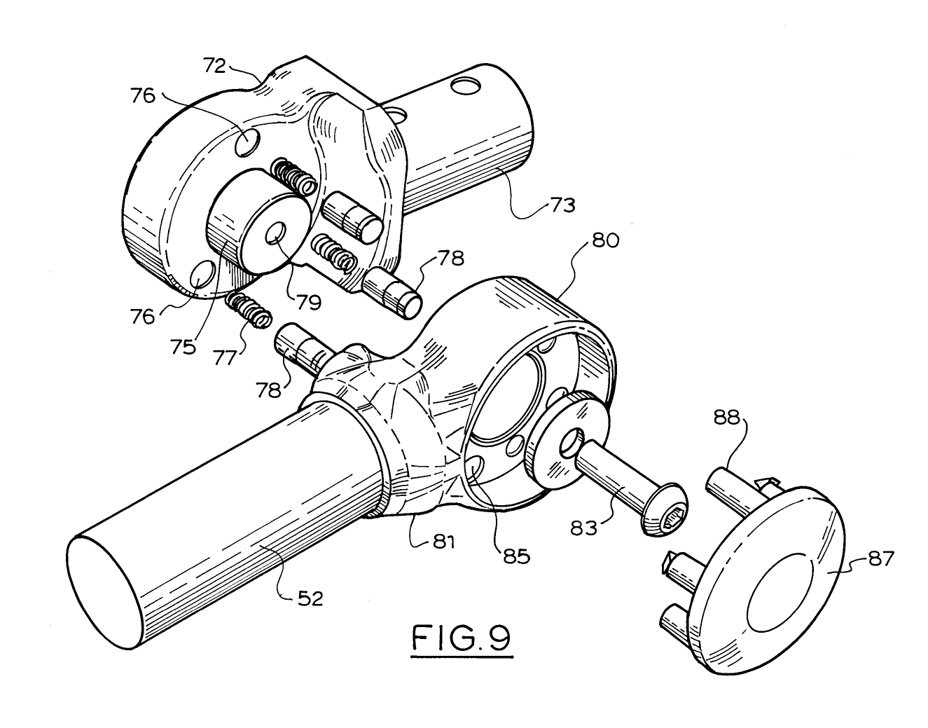

FIG. 9 is an exploded view of the arm connection mechanism of the embodiment of FIG. 8;

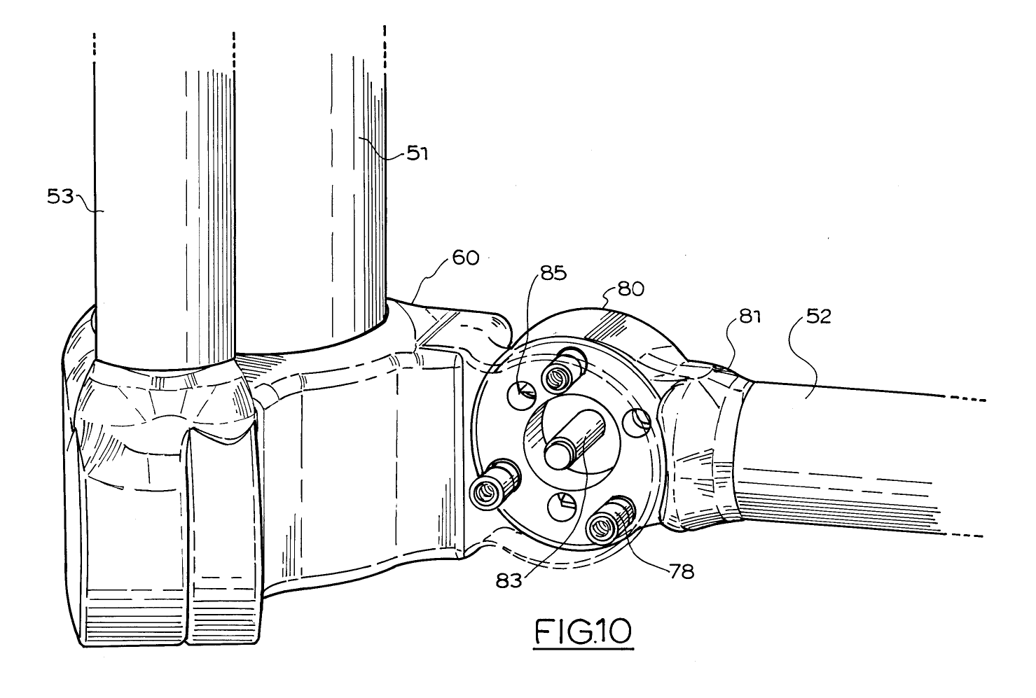

FIG. 10 is a sectional view of the arm mechanism of FIG. 9 in the extended position;

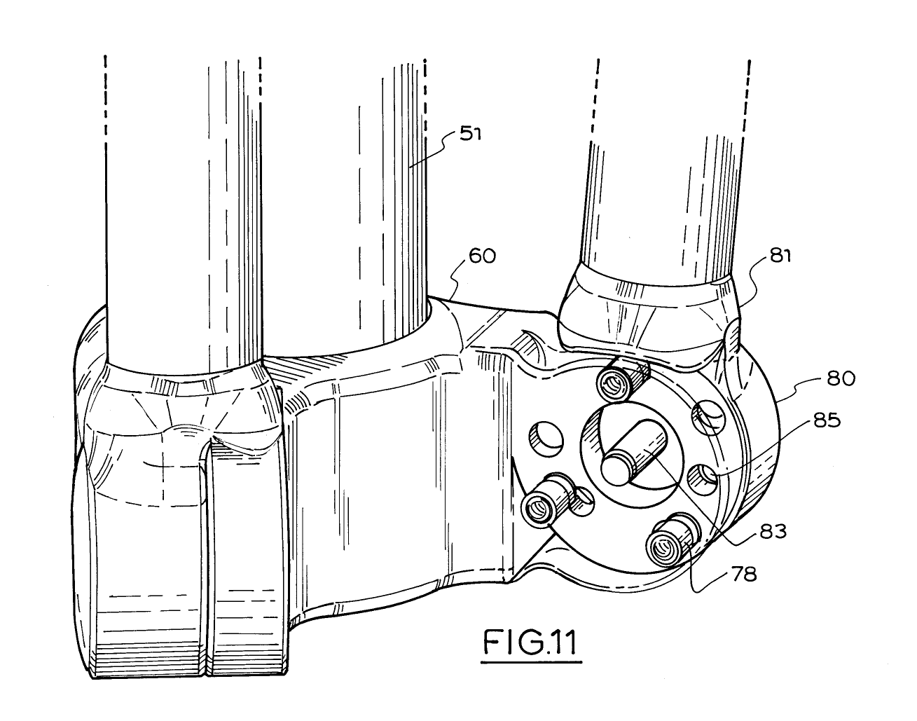

FIG. 11 is a sectional view of the arm mechanism of FIG. 9 as it approaches the folded position.

As shown in FIGS. 1 to 4 the first embodiment of the bed post consists of a vertical post 11 inserted into the vertical post hole 21 of the base connector 20. The under mattress arms 12 and 13 are locked into the operative recesses 22 of the base connector 20.

Each of arms 12 and 13 have a spring loaded pin 16 which locks the arms into the base 20 by engaging with the pin locking hole 24.

In the folded position as shown in FIG. 4 the arms 12 and 13 have been removed from the base 20 by depressing the pin 16 and the reinserting the arms 12 and 13 in the folding recesses 23.

A second embodiment is illustrated in FIGS. 5 to 7 avoids removal and reassembly of the arms by having the arms pivotally attached to the base and moveable from an operative to a folded position.

The bed post of this embodiment consists of a vertical post 31 inserted into the vertical post hole 41 of the base connector 40. The under mattress arms 32 and 33 are lockable in two positions in the pivot recess 42 of base connector 40.

Each of arms 32 and 33 have at their base end a spring loaded shaft 35 which locks into recesses 43 in the sides of the pivot recess 42.

The spring loaded shaft 35 consists of a pair of opposed shaped gears 36 which slide in the complementary shaped passage in the shaft 35 and are pressed outward by the spring 37. The pin 38 locks the spring 37 and gears 36 in place.

The locking components are actuated by pressing the opposed spring loaded button gears 36 that disengage from the recesses 43 allowing the arms 32 and 33 to swing from one position to the other in the pivot recess 42.

In the folded position as shown in FIG. 7 the arms 32 and 33 have been swung into the folded position beside the vertical post 31.

In the embodiment of FIGS. 8 to 11 the bed post consists of a vertical post 51 inserted into the vertical post hole 61 of the base connector 60. The under mattress arms 52 and 53 are lockable in two positions in base connector 60.

Each of arms 52 and 53 have at their base end a mechanism 70 allowing the arms 52 and 53 to be moved from a folded position to an extended position. The mechanism 70 includes a hub 72 with a shaft 73 insertable into base 60. The hub 72 is cylindrical and has a central shaft 75 with a cylindrical recess 79 and 3 radially disposed recesses 76 containing springs 77 and pins 78.

Attachable to each hub 72 is a complementary hub 80 having a socket 81 into which is inserted one of the arms 52 or 53. The hub 80 has a central pin 83 insertable into the recess 79 of the shaft 75 of hub 72. Six radial recesses 85 are sized to receive the pins 78 of hub 72. A press plate 87 with attached pins 88 seats on the back face of hub 80. When the plate 87 is depressed the pins 78 are pushed by pins 88 against the springs 77 so that the hub 81 can be rotated relative to hub 72.

FIG. 10 shows the arm 52 in its extended position with the pins 78 seating in the recesses 85 of to lock it in position. In FIG. 11 the arm 52 is about to move into the folded position adjacent post 51 and each pin 78 is about to enter a complementary recess 85 to lock it in position.

Any suitable materials of the appropriate strength may be used to make the device of this invention. For example: in the embodiment of FIGS. 8 to 11 the preferred materials are:

Handle item 51—High strength Aluminium, Composite with carbon fibre or other high strength fibre reinforcement.

Base Connector item 60—High strength Aluminium, Composite alloy steel and high strength fibre reinforcement.

Rotating Knuckle Hub parts 72 and 81, 80, 78—High strength Alloy steel or high strength stainless steel.

Base arms item 52—High strength Aluminium tube or square hollow section, Composite eg carbon fibre composite tube.

Caps end plugs incl 87—plastic, Aluminium.

The foldable bed post of this invention is convenient to carry and stable in use.

Those skilled in the art will appreciate the advantages of this invention. Those skilled in the art will also realise that tis invention may be implemented in embodiments other than those described without departing from the core teachings of the invention.

1. A foldable, portable disability bed support which has a base portion consisting of at least two arms disposable under a mattress and a support attached vertically to the base portion for use in self-supporting a disabled person and the at least two arms are spaced apart and radially attached to the base of the vertical support.

2. A bed support as claimed in claim 1 which includes a base connector to which the vertical post is attached, said base connector adapted to accept attachment of the base arms in either an operative position or in a folded position in which the base arms lie alongside the support post.

3. A bed post as claimed in claim 2 in which the base connector has two recesses for each arm one recess aligning the arm alongside the vertical post and the other recess aligning the arms at right angles to the support post.

4. A bed post as claimed in claim 2 in which the base connector has a pivot recess for each arm and each arm has a spring-loaded lock so that the arms are able to be placed in a folded position alongside the vertical post and an operative position at right angles to the support post.
